(19) United States
(12) Patent Application Publication
(10) Pub. No.: US 2023/0271851 A1
(43) Pub. Date: Aug. 31, 2023

(54) HEAVY METAL ADSORBENT

(71) Applicant: Sinanen Zeomic Co., Ltd., Nagoya-shi (JP)

(72) Inventors: Akio TANIGUCHI, Tokai-shi (JP); Naoyuki INOUE, Ichinomiya-shi (JP)

(73) Assignee: Sinanen Zeomic Co., Ltd., Nagoya-shi (JP)

(21) Appl. No.: 18/173,185

(22) Filed: Feb. 23, 2023

(30) Foreign Application Priority Data
Feb. 25, 2022 (JP) 2022-027587

(51) Int. Cl. C02F 1/28; B01J 20/16; B01J 20/28; C02F 1/62; B01J 20/02

(52) U.S. Cl. CPC C02F 1/281; B01J 20/165; B01J 20/28059; C02F 1/62; B01J 20/0211; B01J 20/28004; B01J 2220/42; C02F 2101/20

(57) ABSTRACT

To provide a heavy metal adsorbent in which elution of aluminum from a zeolite is suppressed. A compound, which is a hydrous oxide or a hydroxide of Si, Ti, Zr, Ce or La, is mixed with the zeolite.

### BACKGROUND OF THE INVENTION

The present invention relates to a heavy metal adsorbent.

### BACKGROUND ART

The lead concentration in tap water is one of water quality standards in Japan because of concerns about health effects of lead. It is believed that lead included in tap water is derived from a lead pipe which was used as a water pipe until the early 1900s.

A zeolite (aluminosilicate-based inorganic ion exchanger) capable of adsorbing heavy metals such as lead included in water is used as an adsorbent for water purifier (PTL 1).

Meanwhile, the zeolite has a problem that aluminum, which is a constituent element of the zeolite, elutes into purified water when immersed in water for a long period of time. There have been known, as means for solving this problem, technologies to control the volume particle size distribution of zeolite-containing particles in the adsorbent (PTL 2 and PTL 3).

### CITATION LIST

### Patent Literature

[PTL 1] JP 9-99284 A

[PTL 2] JP 2020-163269 A

[PTL 3] JP 2020-163270 A

### SUMMARY OF INVENTION

### Technical Problem

An object to be achieved is to provide new means for suppressing elution of aluminum when a zeolite is used as a heavy metal adsorbent.

### Solution to Problem

As a result of intensive study of the problem, the present inventors have found that it is possible to suppress elution of aluminum from a zeolite when a hydrous oxide or hydroxide of specific metal species is used in combination with the zeolite. The present invention has been made based on these findings.

Namely, the present invention relates to the following [1] to [11].
[1] A heavy metal adsorbent including a compound A, which is a hydrous oxide or a hydroxide of Si, Ti, Zr, Ce or La, and a zeolite.
[2] The adsorbent according to [1], wherein the compound A has a BET specific surface area of 50 m²/g or more.
[3] The adsorbent according to [1] or [2], wherein a 1% by mass water dispersion of the compound A has a pH of 10 or less.
[4] The adsorbent according to any one of [1] to [3], which includes 3% by mass or more of the compound A based on the total mass of the compound A and the zeolite.
[5] The adsorbent according to any one of [1] to [4], wherein the zeolite has a median diameter of is 10 μm or 5 more.
[6] The adsorbent according to any one of [1] to [5], wherein the zeolite is a A-type, X-type, Y-type or P-type zeolite.
[7] The adsorbent according to any one of [1] to [6], wherein an elution amount of aluminum is 5 ppm or less.
[8] The adsorbent according to any one of [1] to [7], which is a lead adsorbent.
[9] The adsorbent according to any one of [1] to [8], which is an adsorbent for water purifier.
[10] A water purifier including the adsorbent according to any one of [1] to [9].
[11] A method for suppressing elution of aluminum from a heavy metal adsorbent including a zeolite, the method including a step of:
   adding a compound A, which is a hydrous oxide or a hydroxide of Si, Ti, Zr, Ce or La, to the adsorbent.

### Advantageous Effects of Invention

As shown in Examples mentioned below, in accordance with the present invention, it is possible to suppress elution of aluminum from a zeolite. Therefore, the present invention can provide a heavy metal adsorbent having the product value not found in conventional products, and a water purifier utilizing the same.

### DESCRIPTION OF EMBODIMENT

The heavy metal adsorbent of the present invention (hereinafter also referred to as “adsorbent”) includes a compound A and a zeolite mentioned below as essential components.

### [Compound A]

The compound A is used to suppress elution of aluminum from a zeolite.

The compound A is a hydrous oxide or a hydroxide of Si, Ti, Zr, Ce or La. The hydrous oxide is also referred to as a hydrated oxide, but is mentioned herein as the hydrous oxide.

The compound A may include two or more of Si, Ti, Zr, Ce and La.

Specific examples of the compound A include the following A1 to A14.

| | |
|---|---|
| A1 | H₄SiO₄, Si (OH) ₄ or SiO₂•2H₂O |
| | (also referred to as orthosilicic acid or silicon |
| | hydroxide) |
| A2 | H₂SiO₃, SiO (OH) ₂ or SiO₂•H₂O |
| | (also referred to as metasilicic acid) |
| A3 | SiO₂•nH₂O (n is a number of 1 or more) |
| | (also referred to as hydrous silicon oxide, and |
| | sometimes |
| | mentioned or referred to by the same name as A2 when n |
| | is 1, or sometimes mentioned or referred to by the same |
| | name as F when n is 2 ) |
| A4 | H₄TiO₄, Ti (OH) ₄ or TiO₂•2H₂O |
| | (also referred to as orthotitanic acid or titanium |
| | hydroxide) |
| A5 | TiO (OH) ₂ or TiO₂•H₂O |
| | (also referred to as metatitanic acid) |
| A6 | TiO₂•nH₂O (n is a number of 1 or more) |
| | (also referred to as hydrous titanium oxide, and |
| | sometimes |
| | mentioned or referred to by the same name as A5 when n |
| | is 1, or sometimes mentioned or referred to by the same |
| | name as A4 when n is 2) |
| A7 | Zr (OH) ₄ |
| | (also referred to as zirconium hydroxide) |
| A8 | ZrO (OH) ₂ |
| | (also referred to as zirconium oxyhydroxide) |
| A9 | ZrO₂•nH₂O (n is a number of 1 or more) |
| | (also referred to as hydrous zirconium oxide, and |
| | sometimes |
| | mentioned or referred to by the same name as A8 when n |
| | is 1, or sometimes mentioned or referred to by the same |
| | name as A7 when n is 2) |
| A10 | Ce (OH) ₄ |
| | (also referred to as cerium hydroxide) |
| A11 | CeO₂•nH₂O (n is a number of 1 or more) |
| | (also referred to as hydrous cerium oxide, and |
| | sometimes |
| | mentioned or referred to by the same name as A10 when n |
| | is 2) |
| A12 | La (OH) ₃ |
| | (also referred to as lanthanum hydroxide) |
| A13 | La₂O₃•nH₂O (n is a number of 1 or more) |
| | (also referred to as hydrous lanthanum oxide, and |
| | sometimes |
| | mentioned or referred to by the same name as A12 when n |
| | is 3) |
| A14 | TiO₂•ZrO₂•nH₂O (n is a number of 1 or more) |
| | (also referred to as titanium-zirconium composite |
| | hydrous oxide) |

Of these, a hydrous oxide or a hydroxide of Ti, Zr or Ce is preferable, and metatitanic acid is more preferable.

The BET specific surface area of the compound A is preferably 50 m²/g or more, more preferably 100 m²/g or more, and particularly preferably 200 m²/g or more. When the BET specific surface area is 50 m²/g or more, it is possible to further suppress elution of aluminum from a zeolite.

The BET specific surface area can be measured in accordance with the following method.

### [Method for Measuring BET Specific Surface Area of Compound A]

Using a fully automatic gas adsorption analyzer (AutosorbiQ, manufactured by Quantachrome Instruments), the measurement is performed. Specifically, the measurement is performed by an argon adsorption method (87.45 K) and then the specific surface area is determined by analysis using a BET multipoint adsorption method. As a pretreatment of a sample, vacuum degassing is performed at 200° C. for 6 hours.

The pH of a 1% by mass water dispersion of the compound A is preferably 10 or less.

Of (A1) to (A13) mentioned above, examples of those in which the pH of a 1% by mass water dispersion is 10 or less include the above-mentioned A5 (pH: 3.3), A7 (pH: 4.5), A3 (pH: 7.5) and the like.

The pH of the compound A can be measured by the following method.

### [Method for Measuring pH of Compound A]

1 g of a compound A is added to 99 g of ion-exchanged water (25° C.), followed by stirring for 5 minutes to prepare a water dispersion (slurry). The pH of the water dispersion is measured by a glass electrode pH meter (for example, F-52, manufactured by HORIBA, Ltd.).

The compound A is a known substance, and is easily available on the market or can be prepared.

Examples of a commercially available product of metatitanic acid include “ST-C”, manufactured by Sakai Chemical Industry Co., Ltd.

Examples of a commercially available product of zirconium hydroxide include “R Zirconium Hydroxide”, manufactured by DAIICHI KIGENSO KAGAKU KOGYO CO., LTD.

Examples of a commercially available product of hydrous silicon oxide include “SILYSIA”, manufactured by FUJI SILYSIA CHEMICAL LTD.

The compound A including a Ti element can be prepared, for example, in accordance with the following method.

A water-soluble metal salt of Ti (for example, titanyl sulfate) is dissolved in water to obtain an aqueous solution. Under stirring, an alkali (for example, sodium hydroxide) is added dropwise to increase the pH of the aqueous solution, thus obtaining a precipitate. The precipitate is ripened (for example, at 5 to 100° C. for 1 to 24 hours) and then subjected to solid-liquid separation, water washing and drying (for example, at 50 to 200° C. for 1 to 100 hours) to obtain a compound A.

The BET specific surface area of the compound A can be controlled by changing the type and the pH of the alkali to be used for production of a precipitate, the ripening temperature and the drying temperature.

Control of the drying temperature to 200° C. or lower is preferable because it prevents the compound A from undergoing dehydration condensation and changing into a metal oxide.

The compound A including a Si element can be prepared by adding dropwise an acid (for example, sulfuric acid) to a sodium silicate solution.

The compound A may be used alone, or a plurality thereof may be used in combination.

The content of the compound A is preferably 3% by mass or more, more preferably 10 to 50% by mass, and particularly preferably 20 to 40% by mass, based on the total mass of the compound A and the zeolite. When the content is 3% by mass or more, it is possible to obtain higher aluminum elution suppression effect.

### [Zeolite (Aluminosilicate)]

In the present invention, a zeolite adsorbing heavy metal can be used without any limitations.

The zeolite may be either a synthetic zeolite or a natural zeolite, and is preferably a synthetic zeolite.

Examples of the synthetic zeolite include an A-type zeolite, an X-type zeolite, a Y-type zeolite, a P-type zeolite, a T-type zeolite, an L-type zeolite, a β-type zeolite and the like. Of these, an A-type, X-type, Y-type or P-type zeolite is preferable.

Examples of the natural zeolite include sodalite, mordenite, analcime, clinoptilolite, chabazite, erionite and the like.

The median diameter of the zeolite is preferably 10 μm or more, more preferably 10 to 1,000 μm, and particularly preferably 20 to 50 μm. When the median diameter is 10 μm or more, it is possible to reduce outflow of the adsorbent from a water purifier filter and clogging of the filter.

The median diameter can be measured in accordance with a laser diffraction/scattering particle size distribution analysis method.

The zeolite is a known substance, and is easily available on the market or can be prepared. Examples of a commercially available product include “Zeomic”, manufactured by Sinanen Zeomic Co., Ltd.

The zeolite may be used alone, or a plurality thereof may be used in combination.

### [Optional Components]

The adsorbent of the present invention can be used in combination with optional components such as activated carbon as long as the effects of the invention are not impaired.

### [Activated Carbon]

An activated carbon is mixed to remove hazardous organic compounds (for example, trihalomethane and formaldehyde) included in water, chlorine odor and moldy odor.

The activated carbon may be in the form of either powder, particle or fiber.

The activated carbon is a known substance, and is easily available on the market or can be prepared.

The activated carbon may be used alone, or a plurality thereof may be used in combination.

The content of the activated carbon is not particularly limited as long as the amount is sufficient to achieve the purpose of mixing, and is preferably 100 to 2,000% by mass, and more preferably 500 to 1,500% by mass, based on the total mass of the heavy metal adsorbent.

### [Elution Amount of Aluminum]

In the adsorbent including a compound A, elution of aluminum from a zeolite is suppressed. The elution amount of aluminum determined by the measurement method mentioned below is preferably 5 ppm or less, more preferably 2 ppm or less, and particularly preferably 1 ppm or less.

### [Method for Measuring Elution Amount of Aluminum]

An adsorbent is added to simulated tap water (leaching solution defined in JIS S3200-7: pH of 7.0±0.1, hardness of 45±5 mg/L, alkalinity of 35±5 mg/L, residual chlorine of 0.3 mg±0.1 mg/L) to prepare a mixture (addition amount: the amount required to control the amount of a zeolite included in the adsorbent to 1% by mass based on the mass of simulated tap water).

Using a constant-temperature incubator shaker (for example, BioShaker (registered trademark), manufactured by TIETECH CO., LTD.), the mixture is stirred at 25° C. and 170 rpm for 24 hours.

After stirring, the mixture is subjected to solid-liquid separation using a membrane filter (pore diameter: 0.45 μm).

The amount of aluminum in the separated liquid is measured by an atomic absorption photometer and the measured value is defined as an elution amount.

### [Method for Producing Adsorbent]

An adsorbent can be produced, for example, by charging a predetermined amount of a zeolite and a compound A in a mixer in a powder state (for example, powder having a particle size of 100 μm or less), followed by mixing (for example, for several minutes to several hours) until they become uniform.

The mixer is not particularly limited, and it is possible to industrially use a rocking mixer, a ribbon mixer, a Henschel mixer and the like.

Alternatively, the adsorbent can also be produced by putting a zeolite and a compound A into water, followed by stirring with a propeller stirrer to prepare a slurry including both components dispersed therein uniformly, and further subjecting to solid-liquid separation and drying.

It is possible to produce an activated carbon filter for water purifier, including the adsorbent of the present invention and an activated carbon used in combination (carbon block, etc.), for example, by mixing an activated carbon and an adsorbent, or an activated carbon, a compound A and a zeolite with a predetermined amount of a binder (polyethylene powder, fibrillated fiber, etc.) and then subjecting the mixture to a molding step.

### [Heavy Metal to be Adsorbed]

Although there is no particular limitation on the type of heavy metal to be adsorbed, the heavy metal may be appropriately selected based on the type of the zeolite. Examples of the heavy metal include lead, cadmium, zinc and the like. The A-type, X-type, Y-type or P-type zeolite is preferable because it is suited for removal of lead, cadmium and zinc. The present invention is particularly suited for removal of lead.

### [Applications of Adsorbent]

An adsorbent can be used to remove heavy metal from water (particularly, tap water).

Particularly, the adsorbent can be suitably used as an adsorbent for water purifier, which removes lead from tap water.

[Method for Suppressing Elution of Aluminum from Heavy Metal Adsorbent Including Zeolite]

A compound A suppresses elution of aluminum from a zeolite. Therefore, the invention relating to an adsorbent can also be understood as a method for suppressing elution of aluminum from a zeolite-containing heavy metal adsorbent, the method comprising using a compound A.

The contents mentioned about the adsorbent are applied to the descriptions of the compound A and the zeolite.

### EXAMPLES

The present invention will be further described in detail below by way of Examples, but the present invention is not limited thereto.

### [Compound A]

The following compounds 1 to 10 were used.

In accordance with the measurement method mentioned above, the BET specific surface area and the pH of each compound were measured.

The measured values are shown in Tables 1 to 2.

### [Compound 1]

Titanyl sulfate (80 g) was dissolved in water (500 ml) to obtain an aqueous solution. To the aqueous solution under stirring at 90° C., sodium hydroxide (concentration: 25%) was added dropwise to adjust the pH to 3.5, thus obtaining a precipitate. The precipitate was ripened (at 90° C. for 18 hours) and then subjected to solid-liquid separation, water washing, drying (at 100° C. for 24 hours) and pulverization to obtain a compound 1 which is metatitanic acid.

### [Compound 2]

In the same manner as in the compound 1, except that sodium hydroxide was added dropwise to adjust the pH to 7.0, a compound 2, which is orthotitanic acid, was obtained.

[Compound 2b]

The same operation as in the preparation of the compound 2 was performed, except that the pH was adjusted to 11.0, a compound 2b, which is orthotitanic acid having a BET specific surface area of 9 m²/g, was obtained.

### [Compound 3]

“R Zirconium Hydroxide” sold by DAIICHI KIGENSO KAGAKU KOGYO CO., LTD. was designated as a compound 3 (zirconium hydroxide).

### [Compound 4]

“SILYSIA 350” sold by FUJI SILYSIA CHEMICAL LTD. was designated as a compound 4 (hydrous silicon oxide).

### [Compound 5]

Cerium nitrate hexahydrate (10 g) was dissolved in water (500 ml) and then a hydrogen peroxide solution was added in the amount equimolar to cerium and, after stirring, ammonia water was further added to adjust the pH to 10, thus obtaining a precipitate. The precipitate was ripened (at room temperature for 6 hours) and then subjected to solid-liquid separation, water washing, drying (at 100° C. for 24 hours) and pulverization to obtain a compound 5, which is hydrous cerium oxide.

### [Compound 6]

Titanyl sulfate (19 g) and zirconyl oxychloride octahydrate (32 g) were dissolved in water (500 ml) to obtain an aqueous solution. To the aqueous solution under stirring at room temperature, sodium hydroxide having a concentration of 2 M was added dropwise to adjust the pH to 11, thus obtaining a precipitate. The precipitate was ripened (at room temperature for 18 hours) and then subjected to solid-liquid separation, water washing, drying (at 100° C. for 24 hours) and pulverization to obtain a compound 6 which is a titanium-zirconium composite hydrous oxide.

### [Compound 7]

Lanthanum chloride heptahydrate (27 g) was dissolved in water (500 ml) to obtain an aqueous solution. To the aqueous solution under stirring at room temperature, ammonia water (concentration: 5%) was added dropwise to adjust the pH to 10, thus obtaining a precipitate. The precipitate was ripened (at room temperature for 24 hours) and then subjected to solid-liquid separation, water washing, drying (at 100° C. for 24 hours) and pulverization to obtain a compound 7 which is a hydrous lanthanum oxide.

### [Compound 8]

Titanium oxide (guaranteed reagent) sold by KISHIDA CHEMICAL CO., LTD. was designated as a compound 8.

The compound 8 does not correspond to a hydrous oxide and a hydroxide of titanium and is therefore used in Comparative Examples.

### [Compound 9]

Lanthanum oxide (guaranteed reagent) sold by KISHIDA CHEMICAL CO., LTD. was designated as a compound 9.

Since the compound 9 does not correspond to a hydrous oxide and a hydroxide of lanthanum, it was used in Comparative Examples.

### [Compound 10]

Magnesium hydroxide (guaranteed reagent) sold by KISHIDA CHEMICAL CO., LTD. was designated as a compound 10 (composition formula: Mg(OH)₂).

Since the compound 10 includes none of Si, Ti, Zr, Ce and La, it was used in Comparative Examples.

### [Compound 11]

Strontium hydroxide (guaranteed reagent) sold by KISHIDA CHEMICAL CO., LTD. was designated as a compound 11.

Since the compound 11 includes none of Si, Ti, Zr, Ce and La, it was used in Comparative Example.

### [Zeolite]

An X-type zeolite, an A-type zeolite, a Y-type zeolite and a P-type zeolite manufactured by Sinanen Zeomic Co., Ltd. (product name: Zeomic, all of them are synthetic zeolites) were used.

The median diameter of each zeolite was measured in accordance with a laser diffraction/scattering particle size distribution analysis method.

### <Measurement Conditions>

Measurement device: MT3300EXII, manufactured by MicrotracBEL Corp.
Basis: Volume basis
Solvent: Water
Refractive index of particles: 1.39
Ultrasonication: 120 seconds (40 W)

The median diameter of each zeolite is shown in Table 1 (X-type) and Table 2 (A-type, P-type and Y-type).

### [Production of Adsorbent]

An adsorbent was prepared by dry mixing of a predetermined mass of a zeolite and a compound A in a rocking mixer so that the content of the compound A in the adsorbent (% by mass) is controlled to the value shown in Tables 1 to 2.

In Tables 1 to 2, “content (% by mass)” of the compound A is the content (% by mass) of the compound A based on the total mass of the compound A and the zeolite.

### [Evaluation of Adsorbent]

### [Elution Amount of Aluminum]

According to the measurement method mentioned above, “elution amount of aluminum” from the adsorbent was measured.

The results are shown in Tables 1 to 2.

### [Adsorption of Lead]

The adsorption ability of heavy metal was evaluated using a removal ratio of lead from tap water as an indicator.

“Lead removal ratio” of each adsorbent of Comparative Example 3, and Examples 3 and 7 was measured in accordance with the following procedure.

After weighing 50 mg of each adsorbent in a container made of PP, 500 ml of simulated tap water including 10,000 ppb of lead ions was added thereto, followed by stirring (rotational speed: 150 rpm) with a propeller stirrer for 24 hours.

After 24 hours, solid-liquid separation was performed using a membrane filter (pore diameter: 0.45 μm) and then the lead ion concentration in the separated liquid was measured by an atomic absorption photometer. The lead removal ratio was determined in accordance with the following calculation formula.

Lead removal ratio (%)=((a−b)/a)×100 (%)
a: lead ion concentration (10,000 ppb) before addition of adsorbent
b: lead ion concentration after addition of adsorbent, followed by stirring for 24 hours.

The results are shown in Table 3.

### INDUSTRIAL APPLICABILITY

The present invention can be utilized in the technical field where removal of heavy metal is requited, particularly water purifier field.

TABLE 1

| | Adsorbent | | | | | | |
|---|---|---|---|---|---|---|---|
| | | | Compound A | | | | |
| | Zeolite | | | | BET | | Aluminum |
| | | Median | | Content | specific | | elution |
| | | diameter | | (% by | surface area | | amount |
| | Type | (μm) | Type | mass) | (m²/g) | pH | [ppm] |
| Comparative | X- | 4.4 | — | — | — | — | 9.1 |
| Example 1 | type | | | | | | |
| Comparative | X- | 10.7 | — | — | — | — | 6.2 |
| Example 2 | type | | | | | | |
| Comparative | X- | 26.7 | — | — | — | — | 2.5 |
| Example 3 | type | | | | | | |
| Comparative | X- | 38.5 | — | — | — | — | 2.3 |
| Example 4 | type | | | | | | |
| Comparative | X- | 43.5 | — | — | — | — | 3.6 |
| Example 5 | type | | | | | | |
| Example 1 | X- | 4.4 | Compound 1 | 30 | 221 | 3.3 | 3.7 |
| | type | | (Metatitanic acid) | | | | |
| Example 2 | X- | 10.7 | Compound 1 | 30 | 221 | 3.3 | 0.9 |
| | type | | (Metatitanic acid) | | | | |
| Example 3 | X- | 26.7 | Compound 1 | 30 | 221 | 3.3 | 0.5 |
| | type | | (Metatitanic acid) | | | | |
| Example 4 | X- | 26.7 | Compound 1 | 12 | 221 | 3.3 | 0.6 |
| | type | | (Metatitanic acid) | | | | |
| Example 5 | X- | 26.7 | Compound 1 | 3 | 221 | 3.3 | 0.9 |
| | type | | (Metatitanic acid) | | | | |
| Example 6 | X- | 26.7 | Compound 2 | 30 | 220 | 11.1 | 1.5 |
| | type | | (Orthotitanic acid) | | | | |
| Example 6a | X- | 26.7 | Compound 2b | 30 | 9 | 10.5 | 1.7 |
| | type | | (Orthotitanic acid) | | | | |
| Example 7 | X- | 25.3 | Compound 3 | 30 | 69 | 4.5 | 0.4 |
| | type | | (Zirconium | | | | |
| | | | hydroxide) | | | | |
| Example 8 | X- | 43.5 | Compound 4 | 30 | 300 | 7.5 | 0.1 |
| | type | | (Hydrous silicon | | | | |
| | | | oxide) | | | | |
| Example 9 | X- | 38.5 | Compound 5 | 30 | 123 | 9.9 | 0.1 |
| | type | | (Hydrous cerium | | | | |
| | | | oxide) | | | | |
| Example 10 | X- | 38.5 | Compound 6 | 30 | 350 | 9.8 | 0.3 |
| | type | | (Titanium-zirconium | | | | |
| | | | composite hydrous | | | | |
| | | | oxide) | | | | |
| Example 11 | X- | 43.5 | Compound 7 | 30 | 163 | 8.5 | 0.5 |
| | type | | (Hydrous lanthanum | | | | |
| | | | oxide) | | | | |
| Comparative | X- | 43.5 | Compound 8 | 30 | 15 | 8.2 | 3.4 |
| Example 6 | type | | (Titanium oxide) | | | | |
| Comparative | X- | 43.5 | Compound 9 | 30 | 20 | 6.9 | 3.6 |
| Example 7 | type | | (Lanthanum oxide) | | | | |
| Comparative | X- | 4.4 | Compound 10 | 30 | 63 | 11.5 | 9.2 |
| Example 8 | type | | (Magnesium | | | | |
| | | | hydroxide) | | | | |
| Comparative | X- | 26.7 | Compound 11 | 30 | 43 | 10.8 | 2.4 |
| Example 9 | type | | (Strontium | | | | |
| | | | hydroxide) | | | | |

TABLE 2

| | Adsorbent | | | | | | |
|---|---|---|---|---|---|---|---|
| | | | Compound A | | | | |
| | Zeolite | | | | BET | | Aluminum |
| | | Median | | Content | specific | | elution |
| | | diameter | | (% by | surface area | | amount |
| | Type | (μm) | Type | mass) | (m²/g) | pH | [ppm] |
| Comparative | A- | 40.5 | — | — | — | — | 2.6 |
| Example 10 | type | | | | | | |
| Example 12 | A- | 40.5 | Compound 1 | 30 | 221 | 3.3 | 0.1 |
| | type | | (Metatitanic acid) | | | | |
| Comparative | P-type | 25.1 | — | — | — | — | 3.6 |
| Example 11 | | | | | | | |
| Example 13 | P-type | 25.1 | Compound 3 | 30 | 69 | 4.5 | 0.2 |
| | | | (Zirconium | | | | |
| | | | hydroxide ) | | | | |
| Comparative | Y-type | 13.4 | — | — | — | — | 1.3 |
| Example 12 | | | | | | | |
| Example 14 | Y-type | 13.4 | Compound 4 | 30 | 300 | 7.5 | 0.1 |
| | | | (Hydrous silicon | | | | |
| | | | oxide) | | | | |

TABLE 3

| | Adsorbent | | | | | | | |
|---|---|---|---|---|---|---|---|---|
| | | | Compound A | | | | Concentration | |
| | | | | | BET | | of lead ions | |
| | Zeolite | | | | specific | | after | Lead |
| | | Median | | Content | surface | | adsorption | removal |
| | | diameter | | (% by | area | | treatment | ratio |
| | Type | (μm) | Type | mass) | (m²/g) | pH | (ppb) | (%) |
| Comparative | X- | 26.7 | — | — | — | — | 3 | 99.97 |
| Example 3 | type | | | | | | | |
| Example 3 | X- | 26.7 | Compound 1 | 30 | 221 | 3.3 | 2 | 99.98 |
| | type | | (Metatitanic | | | | | |
| | | | acid) | | | | | |
| Example 7 | X- | 25.3 | Compound 3 | 30 | 69 | 4.5 | 4 | 99.97 |
| | type | | (Zirconium | | | | | |
| | | | hydroxide) | | | | | |

What is claimed is:

1. A heavy metal adsorbent comprising a compound A, which is a hydrous oxide or a hydroxide of Si, Ti, Zr, Ce or La, and a zeolite.

2. The adsorbent according to claim 1, wherein the compound A has a BET specific surface area of 50 m²/g or more.

3. The adsorbent according to claim 1, wherein a 1% by mass water dispersion of the compound A has a pH of 10 or less.

4. The adsorbent according to claim 1, which comprises 3% by mass or more of the compound A based on the total mass of the compound A and the zeolite.

5. The adsorbent according to claim 1, wherein the zeolite has a median diameter of 10 μm or more.

6. The adsorbent according to claim 1, wherein the zeolite is a A-type, X-type, Y-type or P-type zeolite.

7. The adsorbent according to claim 1, wherein an elution amount of aluminum is 5 ppm or less.

8. The adsorbent according to claim 1, which is a lead adsorbent.

9. The adsorbent according to claim 1, which is an adsorbent for water purifier.

10. A water purifier comprising the adsorbent according to claim 1.

11. A method for suppressing elution of aluminum from a heavy metal adsorbent comprising a zeolite, the method comprising a step of:
adding a compound A, which is a hydrous oxide or a hydroxide of Si, Ti, Zr, Ce or La, to the adsorbent.
